(19) United States
(12) Patent Application Publication
(10) Pub. No.: US 2026/0136106 A1
(43) Pub. Date: May 14, 2026

(54) IMAGE CAPTURING APPARATUS WITH AUTOMATIC EXPOSURE CONTROL, EXPOSURE CONTROL METHOD, AND STORAGE MEDIUM

(71) Applicant: CANON KABUSHIKI KAISHA, Tokyo (JP)

(72) Inventor: JUNJI TADA, Tokyo (JP)

(21) Appl. No.: 19/325,775

(22) Filed: Sep. 11, 2025

(30) Foreign Application Priority Data
Nov. 11, 2024 (JP) 2024-196440

(51) Int. Cl. H04N 23/73; H04N 23/611; H04N 23/63; H04N 23/667; H04N 23/76

(52) U.S. Cl. CPC H04N 23/73; H04N 23/611; H04N 23/632; H04N 23/667; H04N 23/76

(57) ABSTRACT

An image capturing apparatus includes a calculation unit and a control unit. The calculation unit calculates a first photometric value based on brightness in a first region of a captured image, and a second photometric value based on brightness in a second region and the first photometric value. The second region is narrower than the first region and corresponds to the focus position during image capture. The control unit adjusts the exposure for image capture. In a case where the image capturing apparatus is set to full-time MF mode and images are being periodically captured, when the user is operating the focus ring, the calculation unit does not calculate the second photometric value, and the control unit adjusts the exposure based on the first photometric value, while when the user is not operating the focus ring, the control unit adjusts the exposure based on the second photometric value.

### BACKGROUND

### Field of the Technology

The present disclosure relates to an image capturing apparatus, an exposure control method, and a storage medium. More particularly, the present disclosure pertains to an image capturing apparatus with automatic exposure control, an exposure control method, and a storage medium.

### Description of the Related Art

In photography using a digital camera, techniques are known in which exposure control is automatically performed by an auto exposure (AE) function. As part of the AE function, there is a known function that performs exposure control such that a subject detected by the digital camera, such as a person's face, is captured with an appropriate brightness. For example, Japanese Patent Application Laid-Open No. 2021-105850 discloses a method in which, when a plurality of subjects are present within the angle of view, a main subject is determined based on the size of the subjects or the like, and exposure is adjusted according to the brightness of the main subject. Additionally, Japanese Patent Application Laid-Open No. 2013-126091 discloses a method in which the amount of change in the imaging area is also identified, and exposure is adjusted based on the brightness of the main subject and the amount of change in the imaging area.

As for focus control, there are an autofocus (AF) mode in which the digital camera automatically adjusts focus, and a manual focus (MF) mode in which a user can arbitrarily adjust the focus position through manual operation. In recent years, a hybrid approach (hereinafter referred to as a “full-time MF mode”) has also been introduced, in which the camera operates in AF mode while still allowing the user to perform manual focus operations.

However, in any of the conventional exposure adjustment methods mentioned above, there is a possibility that exposure hunting may occur.

### SUMMARY

Embodiments described herein are directed to an image capturing apparatus capable, an exposure control method, and a storage medium for enabling natural exposure tracking during a manual focus operation in full-time MF mode.

In one embodiment, an image capturing apparatus includes an image sensor configured to capture an image, at least one processor or circuit, and at least one memory. The memory is coupled to the processor or circuit and stores instructions that, when executed by the processor or circuit, cause the processor or circuit to function as a setting unit, a calculation unit, and a control unit. The setting unit is configured to set the image capturing apparatus to a mode in which a user operation to change a focus position is accepted while autofocus is active. The calculation unit is configured to calculate a first photometric value based on brightness in a first region of the captured image, and a second photometric value based on brightness in a second region and the first photometric value. The second region is narrower than the first region and corresponds to the focus position during image capture. The control unit is configured to adjust the exposure for image capture. In a case where the image capturing apparatus is set to the mode and images are being periodically captured, when the user operation to change the focus position is being performed, the calculation unit does not calculate the second photometric value, and the control unit adjusts the exposure based on the first photometric value, while when the user operation to change the focus position is not being performed, the control unit adjusts the exposure based on the second photometric value.

Features of the present disclosure will become apparent from the following description of embodiments with reference to the attached drawings. The following description of embodiments is described by way of example.

### BRIEF DESCRIPTION OF THE DRAWINGS

FIG. 1 is a block diagram illustrating an overview of the hardware configuration of a camera as an image capturing apparatus according to an embodiment.

FIG. 2 is a flowchart of an exposure control process according to the embodiment.

FIG. 3 is a flowchart of a process for calculating a second photometric value in step S308 of FIG. 2.

FIG. 4 is a schematic diagram for explaining a process performed in step S306 of FIG. 2.

### DESCRIPTION OF THE EMBODIMENTS

Example embodiments will be described in detail with reference to the accompanying drawings. It should be noted that the following embodiments are provided for illustrative purposes only and are not intended to limit the scope of the disclosure. While multiple features are described in the embodiments, the disclosure is not limited to embodiments that incorporate all such features, and various combinations of these features may be contemplated as appropriate. Furthermore, in the drawings, like reference numerals designate like or corresponding components, and duplicative descriptions thereof are omitted to avoid redundancy.

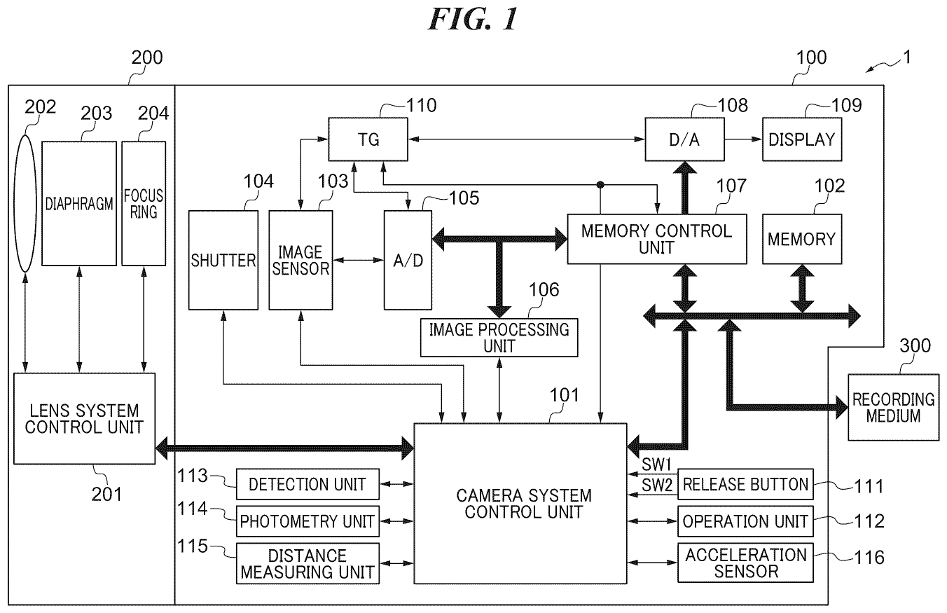

FIG. 1 is a block diagram illustrating an overview of the hardware configuration of a camera 1 as an image capturing apparatus according to an embodiment.

As illustrated in FIG. 1, the camera 1 includes a camera body 100 and a lens unit 200 that is attachable to and detachable from the camera body 100. The configuration of the camera 1 with the lens unit 200 attached to the camera body 100 will be described below with reference to FIG. 1.

The camera body 100 includes a camera system control unit 101, a memory 102, an image sensor 103, a shutter 104, an A/D converter 105, an image processing unit 106, a memory control unit 107, a D/A converter 108, and a display 109. The camera body 100 further includes a timing generator (TG) 110, a release button 111, an operation unit 112, a detection unit 113, a photometry unit 114, a distance measuring unit 115, and an acceleration sensor 116.

The lens unit 200 includes a lens system control unit 201, an imaging lens group 202, a diaphragm 203, and a focus ring 204.

The camera system control unit 101 is configured to comprehensively control various components of the camera body 100. The memory 102 may include a RAM, ROM, or the like connected to the camera system control unit 101. The image sensor 103 is a charge accumulation-type image sensor configured to capture an image, such as a CMOS sensor, which performs photoelectric conversion of a light flux (optical image of a subject) incident through the lens unit 200 and outputs analog image data. The shutter 104 is driven according to a signal from the camera system control unit 101. Specifically, the shutter 104 is controlled to switch between a light-blocking state, in which it shields the image sensor 103 from the light flux incident through the lens unit 200, and a retracted state, in which it guides the optical image of the subject incident through the lens unit 200 to the image sensor 103.

The A/D converter 105 is configured to convert analog image data output from the image sensor 103 into digital image data. The obtained digital image data is stored in the memory 102. The image processing unit 106 performs processing including predetermined image interpolation, resizing (e.g., reduction), color conversion, and calculation of the number of inaccurate pixel data, such as saturated pixels and blacked-out pixels, on data from the A/D converter 105 or data from the memory control unit 107. The D/A converter 108 is configured to convert digital image data stored in the memory 102 into analog image data for display. The display 109 includes a thin-film-transistor liquid-crystal display (TFT LCD) or the like and is configured to display analog image data for display. The display 109 can also perform live view display by sequentially displaying analog image data output from the D/A converter 108. Additionally, the display 109 can also display various types of information other than acquired image data.

The timing generator 110 transmits, to various components of the camera 1, timing signals related to operations within the camera 1, including the exposure timing and the frame rate of the image sensor 103, and the timing for switching the shutter 104 between the light-blocking state and the retracted state.

The release button 111 and the operation unit 112 are used to input various operation instructions to the camera system control unit 101. The release button 111 is used to instruct the start of an image capturing preparation operation and the start of an image capturing operation. When a user performs an operation that changes or sets the release button 111 to an SW1 state (e.g., half-press), an instruction is issued to start the image capturing preparation operation, initiating processes such as distance measurement computation and photometric computation. When the user performs an operation that changes or sets the release button 111 to an SW2 state (e.g., full-press), an instruction is issued to start the image capturing operation, initiating a series of processes from capturing a subject to acquiring an image of the subject. The operation unit 112 is a group of input devices including operating members such as switches, buttons, and dials, which allow the user to input various instructions and perform settings for the camera body 100. For example, the operation unit 112 may include a power switch, a menu button, and directional buttons. Note that the display 109 may be configured as a touch panel display in which a TFT LCD and a capacitive touch panel are integrated, allowing information to be entered via a user interface (UI) displayed on the display 109, similarly to when the operation unit 112 is used.

The detection unit 113 performs a detection process for a specific subject using image data obtained from the image processing unit 106. The photometry unit 114 performs photometric computation using image data obtained from the image processing unit 106. The distance measuring unit 115 performs distance measurement computation (focus detection) using image data obtained from the image processing unit 106. The acceleration sensor 116 detects the movement speed of the camera 1 by detecting its acceleration, for example, when the camera 1 is being panned.

Note that the detection unit 113 and the photometry unit 114 may be configured as being integrated with the camera system control unit 101. In this case, the camera system control unit 101 performs various computations of the detection unit 113 and the photometry unit 114 described above.

The lens system control unit 201 controls the overall operations of the lens unit 200. When the lens unit 200 is attached to the camera body 100, the lens system control unit 201 and the camera system control unit 101 can communicate with each other via an interface (not illustrated). For example, in response to an instruction from the camera system control unit 101, information related to the lens unit 200 attached to the camera body 100 is output to the camera system control unit 101.

The imaging lens group 202 (optical system) is a group of a plurality of lenses, including an optical axis shift lens, a zoom lens, and a focus lens. The diaphragm 203 (optical system) is a light quantity adjustment member configured to adjust the quantity of the light flux transmitted through the imaging lens group 202 and is driven under the control of the lens system control unit 201. Note that the lens unit 200 may be configured without the lens system control unit 201. In this configuration, the operations of the imaging lens group 202 and the diaphragm 203 are controlled according to instructions from the camera system control unit 101.

The focus ring 204 is a ring provided on an outer periphery of the lens unit 200. When the user operates and rotates the focus ring 204, it adjusts the position of the imaging lens group 202, thereby changing the focus position. The amount of rotation of the focus ring 204 caused by the rotational operation is input to the lens system control unit 201, whereby the lens system control unit 201 performs control to adjust the position of the imaging lens group 202 according to the amount of rotation. Hereinafter, this user's operation for changing the focus position by rotating the focus ring 204 is referred to as a manual focus (MF) operation.

The camera 1 may further include a recording medium 300, such as a memory card or a hard disk, which is capable of recording image data stored in the memory 102. Examples of the recording medium 300 include a memory card or the like that is insertable into and removable from the camera body 100. However, the recording medium 300 is not limited thereto. For example, the recording medium 300 may be an optical disk such as a DVD-RW disk, or a magnetic disk such as a hard disk. In addition, the recording medium 300 may be configured to be non-removable and built into the camera body 100 in advance.

The camera 1 of this embodiment has the basic configuration as described above.

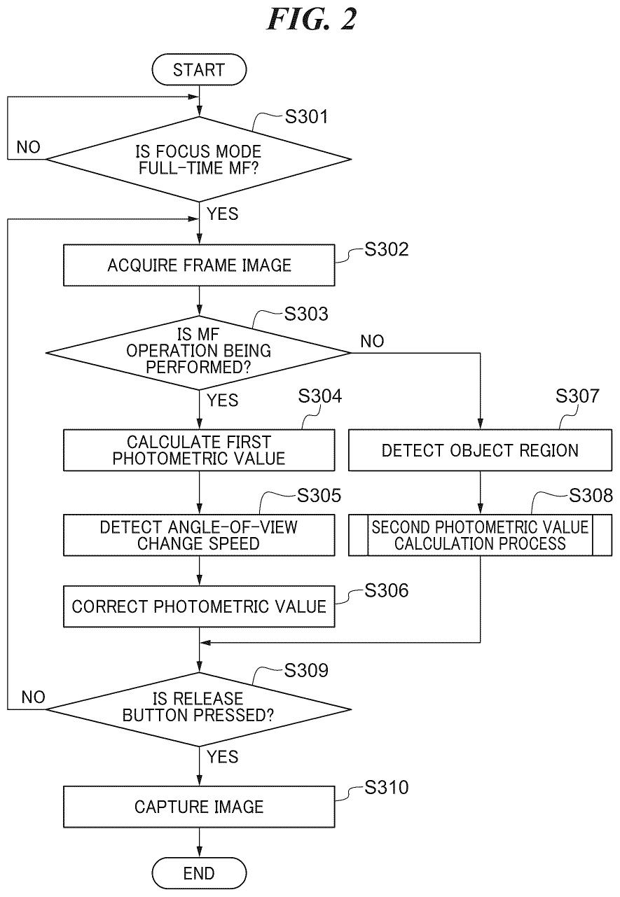

An exposure control process according to the embodiment will be described below with reference to the flowchart of FIG. 2. This process is performed by the camera system control unit 101 by loading a program stored in the ROM of the memory 102 into the RAM of the memory 102.

In step S301, the camera system control unit 101 determines whether the focus mode selected by the user via the operation unit 112 is a full-time MF mode. If it is the full-time MF mode (YES in step S301), the process proceeds to step S302. In this embodiment, the user can select one of the following focus modes: autofocus (AF) mode, manual focus (MF) mode, or full-time MF mode. The full-time MF mode is a hybrid mode in which the camera performs autofocus while accepting an MF operation by the user.

In step S302, the camera system control unit 101 acquires the latest frame image based on a subject image captured via the image sensor 103 and causes the display 109 to display a live view image. The camera system control unit 101 controls the camera 1 so as to periodically capture images and acquire frame images until the release button is pressed in step S309 (described later). The operations in and after step S302 are performed using the latest frame image.

In step S303, the camera system control unit 101 determines whether the user is currently performing an MF operation. If the user has not performed an MF operation for at least a predetermined threshold period, it is determined that the user is not performing the operation (NO in step S303), and the process proceeds to step S307. Otherwise, it is determined that the user is performing the operation (YES in step S303), and the process proceeds to step S304. This threshold time is set in order to stabilize the determination result, as determining whether the user is performing an MF operation based on the latest state could cause the determination result to change frequently.

First, a case will be described in which the camera system control unit 101 determines in step S303 that the user is not performing an MF operation, and the process proceeds to step S307.

In step S307, the detection unit 113 detects, using autofocus, an object region (second region) corresponding to the focus position during image capture. The image processing unit 106 generates a reduced image by downscaling the latest frame image acquired in step S302, and the detection unit 113 performs detection of the object region on the reduced image thus obtained. Typical examples of object regions include face or eye regions of a person or animal, or key parts of vehicles such as cars or trains. Any known method may be used for the detection of the object region, such as using training data of a neural network (see, for example, Japanese Patent Application Laid-Open No. 2006-39666).

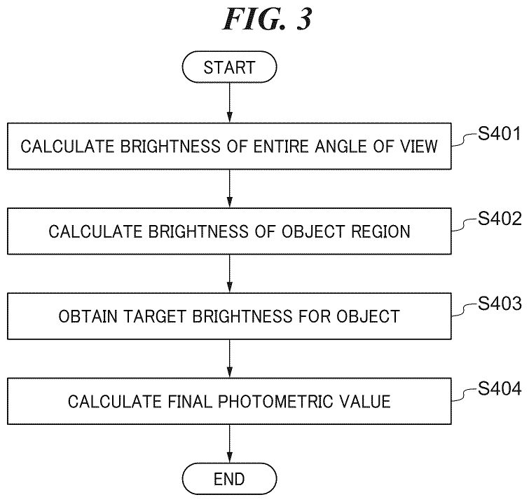

Next, in step S308, the photometry unit 114 performs a second photometric value calculation process. The details of this process will be described with reference to the flowchart of FIG. 3.

In step S401, the photometry unit 114 calculates a first photometric value indicating the brightness of the entire angle of view (first region). In this embodiment, the photometry unit 114 divides the entire angle of view or a predetermined range thereof into blocks and calculates the first photometric value based on the brightness (brightness value) of each block. For example, the first photometric value may be calculated by a simple average of the brightness values of the blocks, or by a weighted average in which greater weight is assigned to blocks closer to the center of the angle of view.

In step S402, the photometry unit 114 calculates the brightness of the object region detected in step S307. In this embodiment, the average of the brightness values of the blocks corresponding to the object region detected in step S307 is calculated as the brightness of the object region.

In step S403, the photometry unit 114 obtains a target brightness for the object. In this embodiment, a target brightness is preset for each type of detectable object, and the target brightness is obtained based on the type of object detected in step S307. Specifically, if the object is an animal, the first photometric value calculated in step S401 is set as the target brightness. If the object is a person, the target brightness is set to be one stop brighter than the first photometric value.

In step S404, the photometry unit 114 calculates a final photometric value. In the present embodiment, this value is set using a method such as balancing the brightness based on the brightness of the entire angle of view (first photometric value) calculated in step S401, the brightness of the object region calculated in step S402, and the target brightness obtained in step S403. The final photometric value is used as the second photometric value. The camera system control unit 101 controls various components of the camera 1 based on the second photometric value to adjust the exposure during image capture such that the images periodically captured in step S302 achieve appropriate brightness. Thereafter, the process of FIG. 3 ends, and the process proceeds to step S309. Specifically, the exposure can be adjusted by controlling the shutter 104, the diaphragm 203 (aperture), and the image sensor 103 to adjust parameters such as exposure time, aperture value, and ISO sensitivity.

Next, a case will be described in which the camera system control unit 101 determines in step S303 that the user is performing an MF operation, and the process proceeds to step S304.

In step S304, the photometry unit 114 calculates a first photometric value. This process may be performed in the same manner as in step S401. However, in this case, the processes of steps S402 to S404 of FIG. 3, namely, the calculation and acquisition of the brightness of the object region and the target brightness for the object, and the calculation of the second photometric value based on the first photometric value and the calculated and acquired brightness, are not performed. This is because, during an MF operation, the primary subject cannot be determined, and performing exposure control based on the second photometric value may instead cause the exposure to fluctuate.

In step S305, the camera system control unit 101 detects the angle-of-view change speed. In this step, the camera system control unit 101 detects the angle-of-view change speed based on information such as the movement speed of the camera 1 detected by the acceleration sensor 116 or the temporal changes in captured image frames calculated by the image processing unit 106. By using temporal changes in captured image frames, it is possible to detect not only the angle-of-view change speed but also scene changes, such as a subject passing across the frame or changes in illumination.

In step S306, the photometry unit 114 corrects the first photometric value calculated in step S304 and obtains a target photometric value. The camera system control unit 101 controls various components of the camera 1 based on the target photometric value such that the images periodically captured in step S302 achieve appropriate brightness, thereby adjusting the exposure during image capture. After that, the process proceeds to step S309.

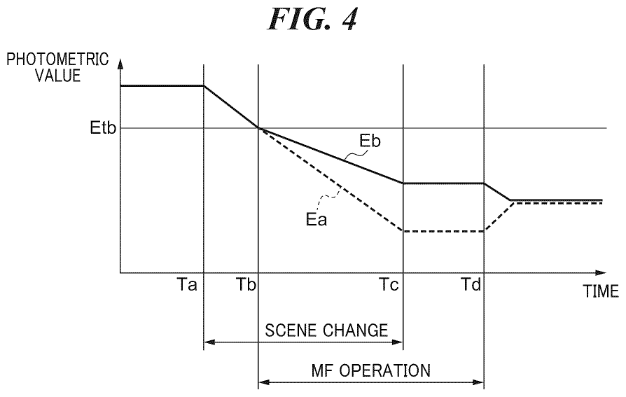

The process in step S306 will be further described with reference to the schematic diagram of FIG. 4.

FIG. 4 is a graph in which the horizontal axis represents the passage of time and the vertical axis represents the photometric value in the full-time MF mode. The period from time Ta to Tc corresponds to a period during which a scene change occurs due to operations such as panning of the camera 1, and the period from time Tb to Td corresponds to a period during which an MF operation is being performed. A dotted line Ea indicates changes in the photometric value in a case where the first photometric value, representing the brightness of the entire angle of view, is calculated during the period from time Ta to Td, and after the MF operation ends at time Td, steps S307 and S308 are performed to calculate the second photometric value. On the other hand, a solid line Eb indicates changes in the photometric value in a case where steps S304 to S306 are performed to calculate the target photometric value during the period from time Ta to Td, and after the MF operation ends at time Td, steps S307 and S308 are performed to calculate the second photometric value.

First, the dotted line Ea will be described. During the period from time Ta to Tc, the photometric value changes in response to the brightness changes of the entire angle of view due to the scene change. During the period from time Tc to Td, as no scene change occurs, the photometric value indicated by the dotted line Ea remains at the first photometric value calculated based on the angle of view at time Tc. However, when the MF operation ends at time Td, autofocus resumes, and the photometric value converges to the value indicated by the dotted line Ea. Here, as illustrated in FIG. 4, the photometric value may change in the opposite direction between the periods from time Ta to Tc and after time Td, resulting in the issue of brightness hunting.

In the present embodiment, to address this issue, the first photometric value is corrected so as to follow the changes in the photometric value indicated by the solid line Eb. Specifically, during the period from time Ta to Tb, the solid line Eb changes in the same manner as the dotted line Ea. However, during the period from time Tb to Tc, in which both a scene change and an MF operation are occurring simultaneously, steps S304 to S306 are performed. In step S306, the amount or speed of change in the solid line Eb relative to the photometric value (Etb) at the start of the MF operation (i.e., at time Tb) is made smaller than the amount or speed of change in the dotted line Ea. In other words, the target photometric value during the period from time Tb to Tc is set to a value obtained by correcting the first photometric value. For example, it may be calculated using Equation (1) as follows:

$$Eb = Etb - α \times ( Etb - Et ) \qquad ( 1 )$$

In Equation (1), Etb represents the photometric value at time Tb, Et represents the first photometric value calculated based on the current angle of view, and Eb represents the current photometric value (target photometric value) resulting from the correction. The parameter a is a correction coefficient, and its value is set within the range of 0 to 1. While the value of a may be a fixed coefficient, it may alternatively be determined to be larger as the angle-of-view change speed detected in step S305 increases. This is because when the angle-of-view change speed is high, the photometric value tends to change significantly, and setting a too small may reduce the tracking performance. As an alternative to Equation (1), a margin may be provided such that the photometric value does not fully track the target photometric value, or the tracking speed of the photometric value may be reduced during an MF operation compared to when no MF operation is being performed.

In this manner, during the period from time Tb to Tc, the amount or speed of change in exposure based on the solid line Eb is reduced compared to that based on the dotted line Ea. On the other hand, during the period from time Tc to Td, as no scene change occurs, the photometric value indicated by the solid line Eb is maintained at the target photometric value calculated based on the angle of view at time Tc. After time Td, a correction based on the brightness of the object region is applied, and the photometric value converges to the same value as indicated by the dotted line Ea.

As described above, by suppressing the tracking of the photometric value during an MF operation, it is possible to achieve a natural exposure transition that is less likely to cause hunting overall. Note that during the period from time Tb to Tc, exposure control is performed using the first photometric value without calculating the second photometric value, which may be notified to the user when the display 109 displays a live view. For example, the notification may be performed by changing the display of a frame indicating the focus position, such as switching from a solid line display to another display format (e.g., a blinking display).

Referring back to FIG. 2, in step S309, the camera system control unit 101 determines whether the release button has been pressed. If the button has been pressed (YES in step S309), the process proceeds to step S310. In step S310, an image capturing process is performed, and then the process of FIG. 2 ends. On the other hand, if the button has not been pressed (NO in step S309), the process returns to step S302.

As described above, according to the present embodiment, natural exposure tracking can be achieved during an MF operation in the full-time MF mode.

Note that although the image capturing apparatus of the above embodiment has been described as a digital camera for personal use, it is not limited thereto. Specifically, any device, such as a portable device, a smartphone, or a network camera connected to a server, may be applied as the image capturing apparatus of the embodiment, as long as it is equipped with an imaging function, an image composition function, and a user interface for setting the exposure time. In addition, part of the above-described processes may be performed by a portable device, a smartphone, or a network camera connected to a server.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-196440, filed Nov. 11, 2024, which is hereby incorporated by reference herein in its entirety.

What is claimed is:

1. An image capturing apparatus comprising:
an image sensor configured to capture an image;
at least one processor or circuit; and
at least one memory coupled to the at least one processor or circuit and storing instructions that, when executed by the at least one processor or circuit, cause the at least one processor or circuit to function as:
a setting unit configured to set the image capturing apparatus to a mode in which a user operation to change a focus position is accepted while autofocus is active;
a calculation unit configured to calculate a first photometric value based on brightness in a first region of the captured image, and a second photometric value based on brightness in a second region and the first photometric value, the second region being narrower than the first region and corresponding to the focus position during image capture; and
a control unit configured to adjust an exposure for image capture,
wherein in a case where the image capturing apparatus is set to the mode and images are being periodically captured,
when the user operation to change the focus position is being performed, the calculation unit does not calculate the second photometric value, and the control unit adjusts the exposure based on the first photometric value, and
when the user operation to change the focus position is not being performed, the control unit adjusts the exposure based on the second photometric value.

2. The image capturing apparatus according to claim 1, wherein the calculation unit is further configured to calculate a target photometric value, which is obtained by correcting the first photometric value, such that an amount or speed of change in the exposure adjusted based on the first photometric value is smaller than when adjusted based on the second photometric value.

3. The image capturing apparatus according to claim 2, wherein when adjusting the exposure based on the first photometric value, the control unit does not fully track the target photometric value.

4. The image capturing apparatus according to claim 1, wherein
the at least one processor or circuit is further configured to function as a detection unit configured to detect an angle-of-view change speed, and
when adjusting the exposure based on the first photometric value, the control unit sets an amount or speed of change in the exposure during a period in which the user operation to change the focus position is being performed and the angle-of-view change speed is detected.

5. The image capturing apparatus according to claim 1, wherein
the at least one processor or circuit is further configured to function as a detection unit configured to detect an object region corresponding to the focus position during image capture, and
the brightness in the second region corresponds to brightness in the object region.

6. The image capturing apparatus according to claim 5, wherein the detection unit is further configured to detect at least a human face region as the object region.

7. The image capturing apparatus according to claim 1, wherein in a case where the image capturing apparatus is set to the mode, the at least one processor or circuit is further configured to function as a determination unit configured to:
determine that the user operation to change the focus position is not being performed when a user has not performed an operation to change the focus position for at least a predetermined threshold period; and
otherwise, determine that the user operation to change the focus position is being performed.

8. The image capturing apparatus according to claim 4, further comprising a display configured to display the captured image as a live view, wherein
the at least one processor or circuit is further configured to function as a display control unit configure to control the display,
the display control unit displays a frame indicating the focus position on the display, and
the display control unit changes a display format of the frame during the period in which the user operation to change the focus position is being performed and the angle-of-view change speed is detected.

9. An exposure control method comprising:
capturing an image;
setting an image capturing apparatus to a mode in which a user operation to change a focus position is accepted while autofocus is active;
calculating a first photometric value based on brightness in a first region of the captured image, and a second photometric value based on brightness in a second region and the first photometric value, the second region being narrower than the first region and corresponding to the focus position during image capture; and
adjusting an exposure for image capture, wherein in a case where the image capturing apparatus is set to the mode and images are being periodically captured:
the exposure is adjusted based on the first photometric value without calculating the second photometric value when the user operation to change the focus position is being performed; and
the exposure is adjusted based on the second photometric value when the user operation to change the focus position is not being performed.

10. A non-transitory computer-readable medium comprising computer-executable instructions stored thereon that, when executed by a computer, cause the computer to perform:
capture an image;
set an image capturing apparatus to a mode in which a user operation to change a focus position is accepted while autofocus is active;
calculate a first photometric value based on brightness in a first region of the captured image, and a second photometric value based on brightness in a second region and the first photometric value, the second region being narrower than the first region and corresponding to the focus position during image capture; and
adjust an exposure for image capture, wherein in a case where the image capturing apparatus is set to the mode and images are being periodically captured:
the exposure is adjusted based on the first photometric value without calculating the second photometric value when the user operation to change the focus position is being performed; and
the exposure is adjusted based on the second photometric value when the user operation to change the focus position is not being performed.
